(19) United States
(12) Patent Application Publication
(10) Pub. No.: US 2010/0053573 A1
(43) Pub. Date: Mar. 4, 2010

(54) HANDHELD PROJECTOR

(75) Inventors: WEN-FU WEN, Tu-Cheng (TW); CHENG-HUNG CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/411,356

(22) Filed: Mar. 25, 2009

(30) Foreign Application Priority Data
Aug. 27, 2008 (CN) 200810304242.4

(51) Int. Cl. G03B 3/02

(52) U.S. Cl. 353/101

(57) ABSTRACT

A handheld projector includes a housing, a projection lens module defining an optical axis, and an adjusting member movably mounted inside the housing. The projection lens module includes a sleeve, an outer barrel fixing the sleeve therein, an inner barrel received in the outer barrel, and a projection lens received in the inner barrel. The sleeve includes a first sidewall defining a guide groove angled relative to the optical axis. The outer barrel includes a second sidewall defining at least one cam groove angled relative to the optical axis. The projection lens includes at least one cam follower corresponding to the cam groove. The adjusting member includes a first surface facing the projection lens module. A guide post extends from the first surface corresponding to the guide groove. Each cam follower is plugged into the corresponding cam groove. The guide post is plugged into the guide groove.

### BACKGROUND

1. Technical Field

The present disclosure relates to projection technology and, particularly, to a handheld projector.

2. Description of the Related Art

Projectors are widely used in different situations, such as theaters, classrooms, outdoor displays, conferences, and others. Particularly, with the development of projector miniaturization, a handheld projector, carried in a pocket or even integrated into mobile terminals such as mobile phones, personal digital assistants (PDAs) and digital cameras, allows projection onto a surface in almost any environment.

Generally, such handheld projectors include a projection lens module with a focusing ring. Rotation of the focusing ring produces a focused image for projection. One-handed operation of the handheld projectors is, however, difficult, particularly when the user has to adjust the focus ring.

Therefore, what is needed is a handheld projector which can overcome the described limitations.

### BRIEF DESCRIPTION OF THE DRAWINGS

FIG. 1 is a partial, isometric view of a handheld projector, according to an exemplary embodiment.

FIG. 2 shows the handheld projector of FIG. 1 from another angle.

FIG. 3 is an exploded, isometric view of the handheld projector of FIG. 1.

FIG. 4 is an exploded, isometric view of the handheld projector of FIG. 1 from the viewing angle of FIG. 2.

### DETAILED DESCRIPTION

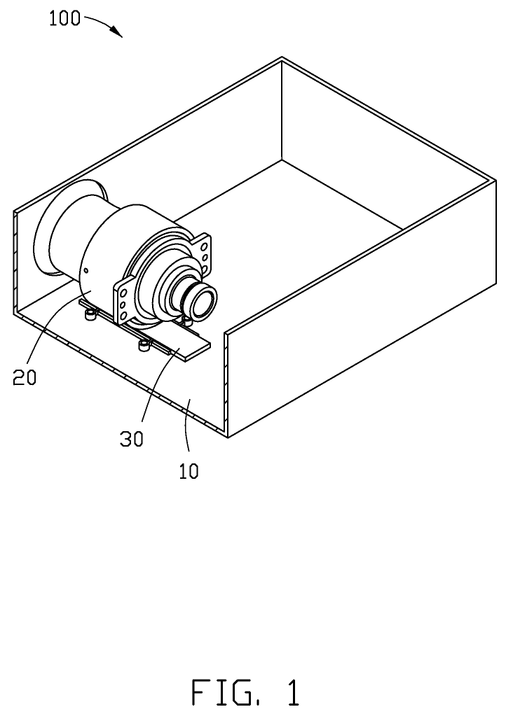

Referring to FIG. 1, a handheld projector 100, according to an exemplary embodiment, includes a housing 10, a projection lens module 20, and an adjusting member 30.

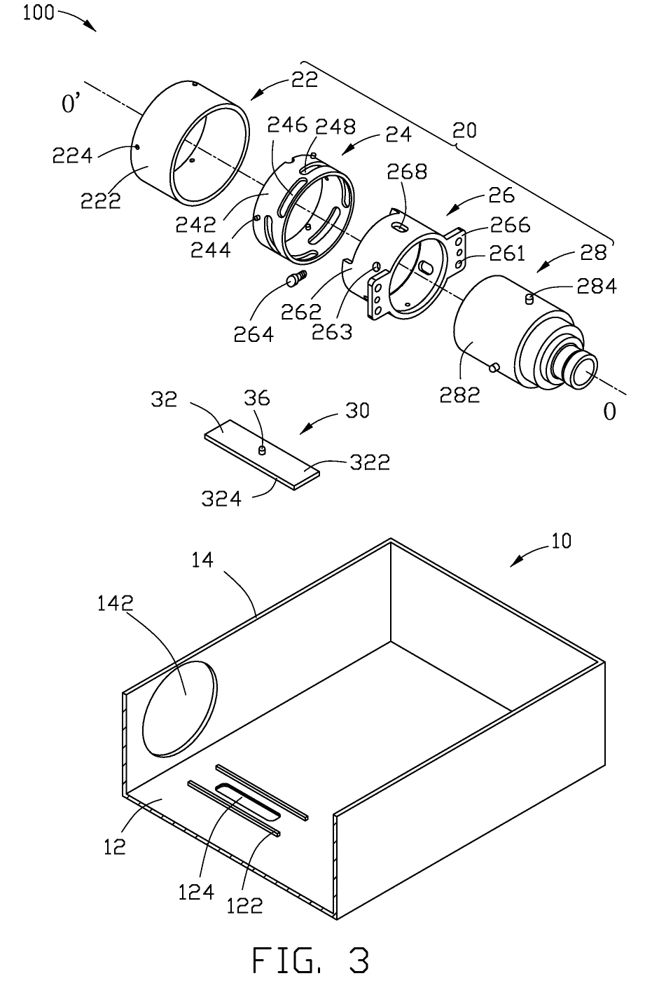

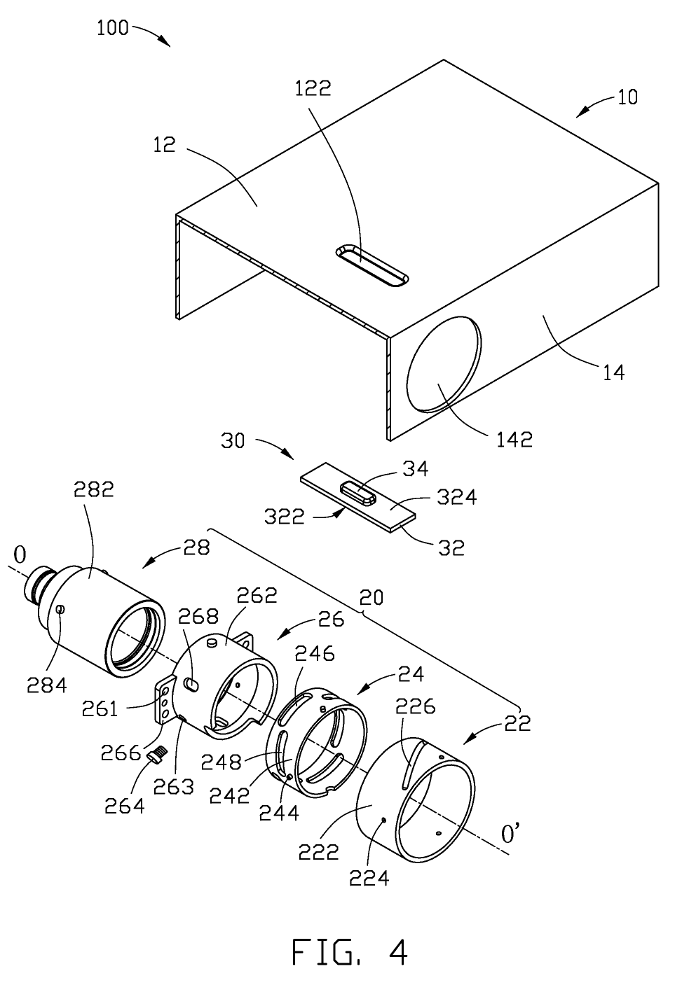

Referring to FIGS. 1, 3 and 4, the housing 10 includes a top plate 12 and a front plate 14 perpendicularly extending therefrom. Two linear rails 122 extend from the top plate 12. A guide slot 124 is defined between the two rails 122 in the top plate 12. An aperture 142 is defined in the front plate 14 corresponding to the guide slot 124.

The projection lens module 20 and the adjusting member 30 are positioned inside the housing 10. The projection lens module 20 faces the aperture 142 to project an image onto a surface (not shown) through the aperture 142. The adjusting member 30, abutting the top plate 12, is positioned between the two linear rails 122 and is configured for moving along the guide slot 124.

The projection lens module 20 includes a sleeve 22, an outer barrel 24, an inner barrel 26, and a projection lens 28 defining an optical axis OO′. The sleeve 22 surrounds the outer barrel 24. The outer barrel 24 surrounds the inner barrel 26. The projection lens 28 is received in the inner barrel 26. The sleeve 22, the outer barrel 24, the inner barrel 26 and the projection lens 28 are concentric and the center lines thereof align with the optical axis OO′ of the projector lens 28.

The sleeve 22 includes a first sidewall 222, in which three fixing holes 224 are symmetrically defined. A guide groove 226 is defined in the first sidewall 222 facing the top plate 12 and angled relative to the optical axis OO′.

The outer barrel 24 includes a second sidewall 242 and three fixing posts 244 radially extending therefrom away from the optical axis OO′, corresponding to the three fixing holes 224. Three retaining slots 246 are defined substantially equidistant from each other along the circumference of the second sidewall 242. Three cam grooves 248 are defined in the second sidewall 242 with locations different from those of the retaining slots 246, angled relative to the optical axis OO′. Each fixing post 244 is engaged in a corresponding fixing hole 224, whereby the sleeve 22 is fixed to the outer barrel 24.

The inner barrel 26 includes a third sidewall 262, three retaining fasteners 264, such as screws or bolts, and two tabs 266 extending from an end of the third sidewall 262. Three retaining through holes 263 corresponding to the three retaining fasteners 264 are radially defined in the third sidewall 262 equidistant from each other therearound. The retaining through holes 263 correspond to the three retaining slots 246 respectively. Each retaining fastener 264 passes through a corresponding retaining slot 246 and is engaged in a corresponding retaining through hole 263, whereby outer barrel 24 is rotatably mounted to the inner barrel 26. As a result, movement of the outer barrel 24 along the optical axis OO′ is restricted by the retaining fastener 264. Three linear slots 268 are defined in the third sidewall 262 corresponding to the three cam grooves 248 and along the optical axis OO′. Three securing through holes 261 are defined in each tab 266, with an axial direction of each securing through hole 261 parallel to the optical axis OO′. Six fasteners (not shown) may pass through the securing through holes 261 to engage an optical engine (not shown) of the handheld projector 100, whereby the projection lens module 20 is secured to the optical engine of the handheld projector 100.

The projection lens 28 includes a fourth sidewall 282 and three cam followers 284 radially extending therefrom away from the optical axis OO′. The cam followers 284 correspond to the linear slots 268 and the cam grooves 248. Each cam follower 284 passes through a corresponding linear slot 268 and the corresponding cam grooves 248, whereby the projection lens 28 is movably received in the inner barrel 26. The projection lens 28 moves forward and backward along the optical axis OO′, by the guidance of the linear slot 268.

The adjusting member 30 includes a body portion 32, a protrusion 34 corresponding to the guide slot 124, and a guide post 36 corresponding to the guide groove 226. The body portion 32 includes a first surface 322 facing the projection lens module 20 and a second surface 324 opposite to the first surface 322. The protrusion 34 extends from the second surface 324. The guide post 36 extends from the first surface 322. The guide post 36 enters into the guide groove 226 and tightly contacts the bottom of the guide groove 226, whereby the sleeve 22 is rotated around the optical axis OO′ with the movement of the adjusting member 30 along the guide slot 124. The second surface 324 abuts the top plate 12 and the protrusion 34 protrudes from the guide slot 124.

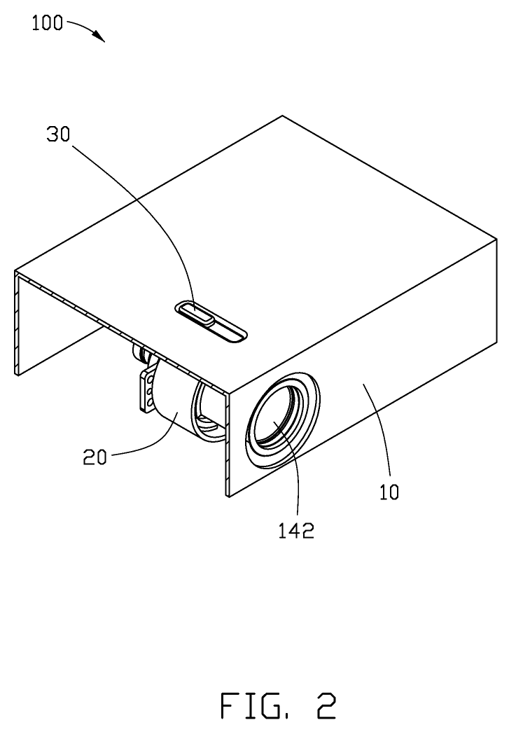

Referring to FIGS. 1-4, when the protrusion 34 is impelled, the adjusting member 30 moves along guide slot 124. The sleeve 22 together with the outer barrel 24 rotates around the optical axis OO′ by engagement of the guide post 36 and the guide groove 226. Each cam follower 284 is contacted by the sidewall of the corresponding cam groove 248 with the rotation of the outer barrel 24, whereby each cam follower 284 slides along the corresponding linear slot 268. As a result, the projection lens 28 is impelled toward or away from the aperture 142 along the optical axis OO′ during focus. In this embodiment, if the protrusion 34 is impelled toward the aperture 142, the sleeve 22 and the outer barrel 24 rotate counterclockwise around the optical axis OO′, and the projection lens 28 is impelled toward the aperture 142 along the optical axis OO′. Otherwise, if the protrusion 34 is impelled away from the aperture 142, the sleeve 22 and the outer barrel 24 rotate clockwise around the optical axis OO′, and the projection lens 28 moves away from the aperture 142. Therefore, one-handed focus of the projected image is fast and simple.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A handheld projector comprising:
a housing;
a projection lens module defining an optical axis, comprising
a sleeve comprising a first sidewall, a guide groove defined on the first sidewall and angled relative to the optical axis;
an outer barrel fixing the sleeve thereon, the outer barrel comprising a second sidewall in which at least one cam groove is defined, and angled relative to the optical axis;
an inner barrel fixed inside the housing and received in the outer barrel, the outer barrel being rotatable relative to the inner barrel;
a projection lens received in the inner barrel and configured for moving along the optical axis, the projection lens comprising at least one cam follower corresponding to the at least one cam groove; and
an adjusting member movably mounted to the housing and comprising a body portion having a first surface facing the projection lens module, a guide post extending from the first surface corresponding to the guide groove, the at least one cam follower plugged into the at least one cam groove, the guide post being plugged into the guide groove.

2. The handheld projector as claimed in claim 1, wherein the housing comprises a top plate and a front plate perpendicularly extending therefrom, wherein a guide slot is defined in the top plate, an aperture is defined in the front plate corresponding to the guide slot, the projection lens module is disposed inside the housing and faces the aperture, the adjusting member is movably mounted to the top plate inside the housing, and part of the adjusting member is exposed and operable from the guide slot.

3. The handheld projector as claimed in claim 2, wherein two linear rails extend from the top plate inside the housing, between which the guide slot is defined, and the adjusting member abuts the top plate between the two linear rails and moves along the guide slot.

4. The handheld projector as claimed in claim 2, wherein the exposed part of the adjusting member comprises a protrusion corresponding to the guide slot, the body portion comprises a second surface opposite to the first surface from which the protrusion extends and abutting the top plate, and the protrusion protrudes from the guide slot.

5. The handheld projector as claimed in claim 1, wherein the inner barrel comprises a third sidewall in which at least one linear slot is defined corresponding to the at least one cam groove and the at least one cam follower along the optical axis, and each cam follower passes through the corresponding linear slot and the corresponding cam groove, whereby the projection lens is received in the inner barrel.

6. The handheld projector as claimed in claim 5, wherein at least one retaining slot is defined in the second sidewall along the circumference of the second sidewall, the inner barrel further comprises at least one fastener corresponding to the at least one retaining slot, at least one retaining through hole is defined in the third sidewall corresponding to the at least one fastener, and each retaining fastener passes through the corresponding retaining groove and a corresponding retaining through hole, whereby the outer barrel is mounted to the inner barrel.

7. The handheld projector as claimed in claim 1, wherein the inner barrel is fixed inside the housing by fasteners.

8. The handheld projector as claimed in claim 1, wherein at least one fixing hole is defined in the first sidewall, at least one fixing post radially extending from the second sidewall away from the optical axis corresponding to the at least one fixing holes, each fixing post is engaged in the corresponding fixing hole, whereby the sleeve is fixed to the outer barrel.

9. The handheld projector as claimed in claim 5, wherein the at least one cam groove comprises three cam grooves, and the at least one cam follower comprises three corresponding cam followers, the at least one linear slot comprises three linear slots defined in the second sidewall corresponding to the three cam grooves and the three cam followers, along the optical axis, wherein each cam follower passes through the corresponding linear slot and the corresponding cam groove, whereby the projection lens is received in the inner barrel.

10. The handheld projector as claimed in claim 6, wherein the at least one retaining slot comprises three retaining slots defined in the second sidewall along the circumference of the first sidewall, substantially equidistant from each other around the second sidewall, the at least one fastener comprises three fasteners corresponding to the three retaining slots, three retaining through holes defined in the third sidewall corresponding to the three fasteners; each retaining fastener passes through the corresponding retaining groove and the corresponding retaining through hole, whereby the outer barrel is mounted to the inner barrel.

11. The handheld projector as claimed in claim 8, wherein the at least one fixing hole comprises three fixing holes defined in the first sidewall, the at least one fixing post comprises three fixing posts radially extending from the second sidewall away from the optical axis corresponding to the three fixing holes; each fixing post is engaged in the corresponding fixing hole, whereby the sleeve is fixed to the outer barrel.
